(19) United States
(12) Patent Application Publication
(10) Pub. No.: US 2016/0024739 A1
(43) Pub. Date: Jan. 28, 2016

(54) GROUND MOUNTING ASSEMBLY

(71) Applicant: Stephen KELLEHER, Fairhaven, MA (US)

(72) Inventor: Stephen Kelleher, Fairhaven, MA (US)

(21) Appl. No.: 14/777,441

(22) PCT Filed: Mar. 14, 2014
(86) PCT No.: PCT/US14/28686

§ 371 Date: Sep. 15, 2015

Related U.S. Application Data
(63) Continuation of application No. 13/839,842, filed on Mar. 15, 2013.

(51) Int. Cl. E02D 5/22; E02D 7/30; E02D 27/42; E02D 5/54; H02S 20/10; E02D 27/50; E02D 7/02; E02D 5/60

(52) U.S. Cl. CPC E02D 5/223; E02D 7/02; E02D 7/30; E02D 5/60; E02D 5/54; H02S 20/10; E02D 27/50; E02D 27/425

(57) ABSTRACT

A ground mounting assembly, system and methods for ground mounting a structure include one or a plurality of posts, each of which are attached to at least one stabilizing plate. The posts may be at least partially positioned underground, with the stabilizing plates being buried to a depth of for example, about 1 foot. Posts in a front portion of the mounting assembly optionally may be connected to an adjacent one of posts in a back portion of the assembly by a cross member. A ground mounted post that is driven them lifted to deploy uplift members. A ground mounting system based on a double pounder pile driven mono pole is also described.

This application is a continuation-in-part of U.S. application Ser. No. 13/839,842, filed Mar. 15, 2013, which application in turn is a continuation-in-part of U.S. application Ser. No. 13/676,990, filed Nov. 14, 2012, which application in turn claims priority from U.S. Provisional Application Ser. No. 61/560,037, filed Nov. 15, 2011.

The present disclosure is generally related to ground mounting assemblies, systems and methods for ground mounting structures. The invention has particular utility in connection with ground mounting photovoltaic solar panel assemblies, and will be described in connection with such utility, although other utilities are contemplated, such as docks, wharfs, moorings, and building reinforcements.

Many outdoor structures, such as solar panel assemblies, billboards, signs, docks and wharfs, buildings and the like, are mounted into the ground using posts or poles. Often, these assemblies are subjected to high winds, which can loosen the mounting posts, thereby making the assembly unstable. For example, solar panel assemblies typically have a large surface area for capturing solar energy; however, such assemblies also may be subjected to wind forces, which may be translated into the mounting posts, thereby loosening the soil surrounding the mounting structure. This problem is particularly amplified where such assemblies are mounted in loose or sandy soil. The same is true in docks and wharfs.

In the case of solar panel assemblies, many such assemblies are mounted with posts that do not have sufficient underground surface area to provide adequate resistance to counter the wind forces acting upon the above-ground solar panel assembly. For example, a commonly used post in such assemblies may be about 2.5 inches in width. To address the problem of instability, one known technique involves pouring a cement cap over the entire surface of the mounting structure. However, this is a very costly measure, and further suffers from the disadvantage of making the installation a permanent or semi-permanent fixture. Thus, rearranging, modifying or retrofitting the installation becomes significant undertaking because of the presence of the cap.

Embodiments of the present disclosure provide a ground mounting assembly for mounting a structure, such as a photovoltaic system mounted to a ground mounting assembly, methods for stabilizing a preinstalled ground mounting assembly and methods for ground mounting a structure, including; docks, wharfs, moorings, antennas and building reinforcement. Briefly described, the present disclosure can be viewed as providing mounting assemblies, systems and methods for ground mounting structures utilizing posts having attached stabilizing plates for lateral and/or uplift forces.

In one aspect, the present disclosure provides a ground mounting assembly for mounting a structure, which includes one or a plurality of posts, each post being connected to at least one stabilizing element which may take the form of a flat plat which may be fixed to or togel mounted to the post, or a half-pyramid shaped structure, fixed to the post. A first portion of the one or more plurality of posts may define a front of the mounting assembly, and a second portion of the one or more plurality of posts may define a back of the mounting assembly. Where there are a plurality of posts, each of the front posts may be connected to an adjacent one of the back posts by a cross member.

In another aspect, the present disclosure provides a photovoltaic system, which includes a ground mounting assembly having one or a plurality of posts, each post being connected to at least one stabilizing element. Where there are a plurality of posts, at least two of the plurality of posts may be connected by a cross member, and a solar panel array may be mounted to the ground mounting assembly.

In a further aspect, the present disclosure provides a method of stabilizing a preinstalled ground mounting assembly having one or a plurality of posts buried at least partially in the ground. The method includes the steps of: excavating an area of ground surrounding each of the posts; attaching at least one stabilizing element to each of the posts, in an area exposed by the excavating; and backfilling the excavated area. The method may further include, where there are a plurality of posts: excavating a portion of ground between posts defining a front of the mounting assembly and posts defining a back of the mounting assembly; and attaching a cross member between each of the front posts and an adjacent one of the back posts.

In yet another aspect, the present disclosure provides a method of ground mounting a structure, including the steps of: forming a mounting assembly by driving one or a plurality of posts into the ground, each of the posts being connected to at least one stabilizing element; and attaching the structure to an above-ground portion of the mounting assembly. The method may further include the steps of, where there are a plurality of posts: excavating an area of ground between posts defining a front of the mounting assembly and posts defining a hack of the mounting assembly; attaching a cross member between each of the front posts and an adjacent one of the back posts; and backfilling the excavated area.

The features, functions, and advantages that have been discussed can be achieved independently in various embodiments of the present disclosure or may be combined in yet other embodiments further details of which can be seen with reference to the following description and drawings.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

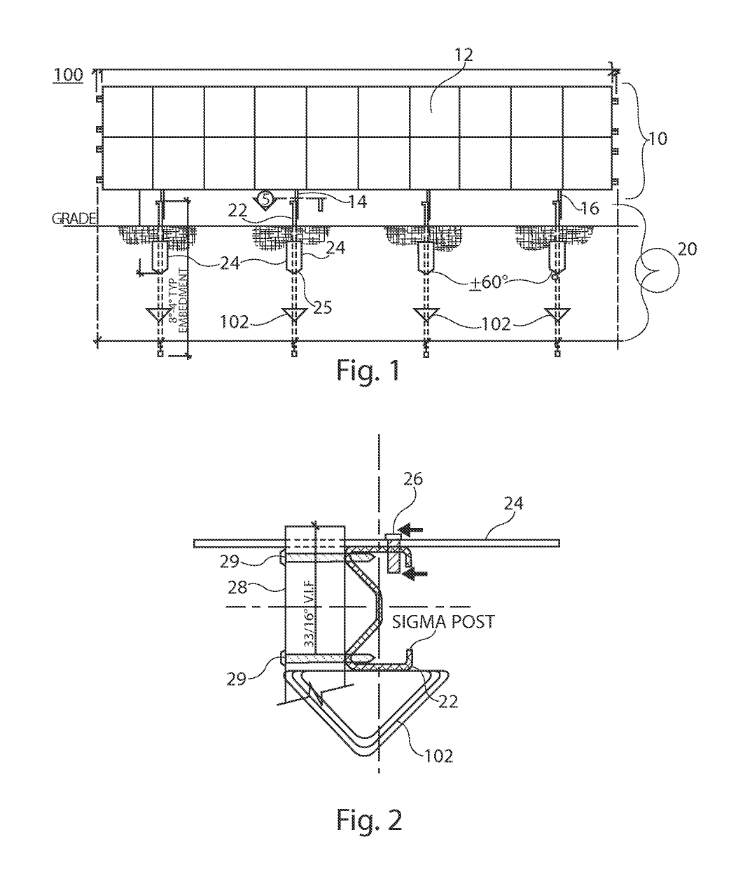

FIG. 1 is an illustration of a front elevation view of a photovoltaic (PV) system, in accordance with an exemplary embodiment of the disclosure.

FIG. 2 is an illustration of a plan section at a post, taken along line 14 of FIG. 1, in accordance with an exemplary embodiment of the disclosure.

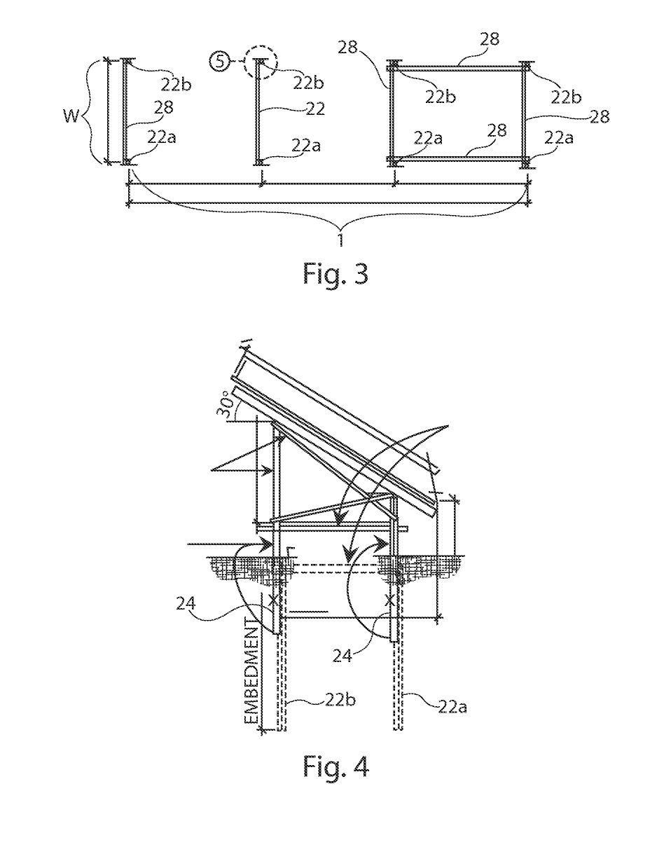

FIG. 3 is an illustration of a plan view of the system shown in FIG. 1, in accordance with an exemplary embodiment of the disclosure.

FIG. 4 is an illustration of a side elevation view of the system shown in FIG. 1, in accordance with an exemplary embodiment of the disclosure.

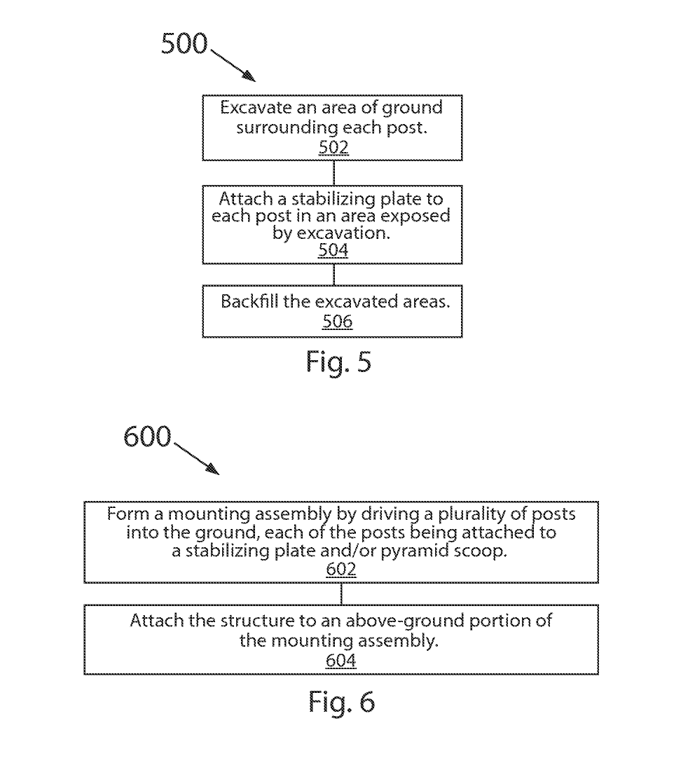

FIG. 5 is a flowchart illustrating a method of stabilizing a preinstalled ground mounting assembly, in accordance with an exemplary embodiment of the disclosure.

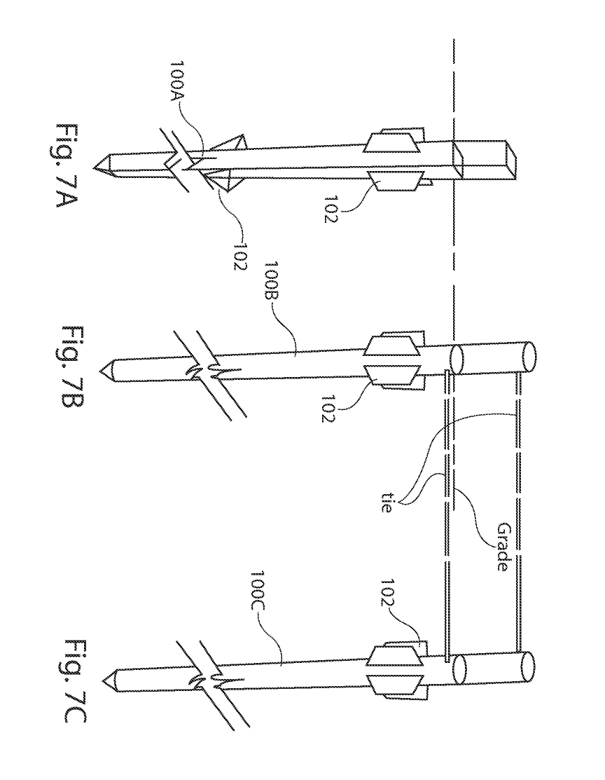

FIG. 6 is a flowchart illustrating a method of ground mounting a structure, in accordance with an exemplary embodiment of the disclosure.

FIGS. 7A-7C are perspective views of alternative embodiments of posts in accordance with the present disclosure.

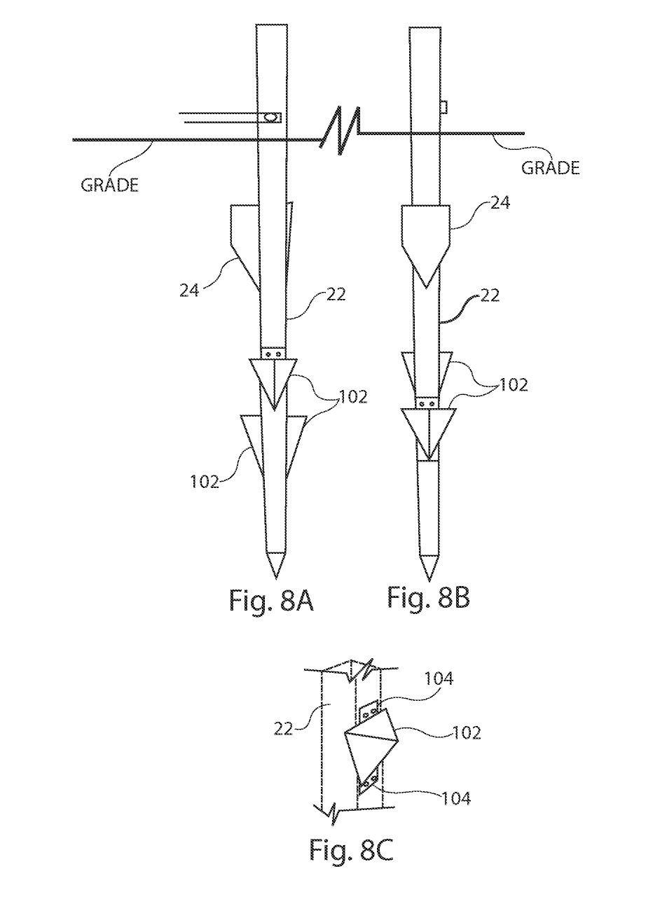

FIGS. 8A-8B are side elevational views, and FIG. 8C is a perspective view, respectively, of yet another alternative embodiment of posts in accordance with the present disclosure.

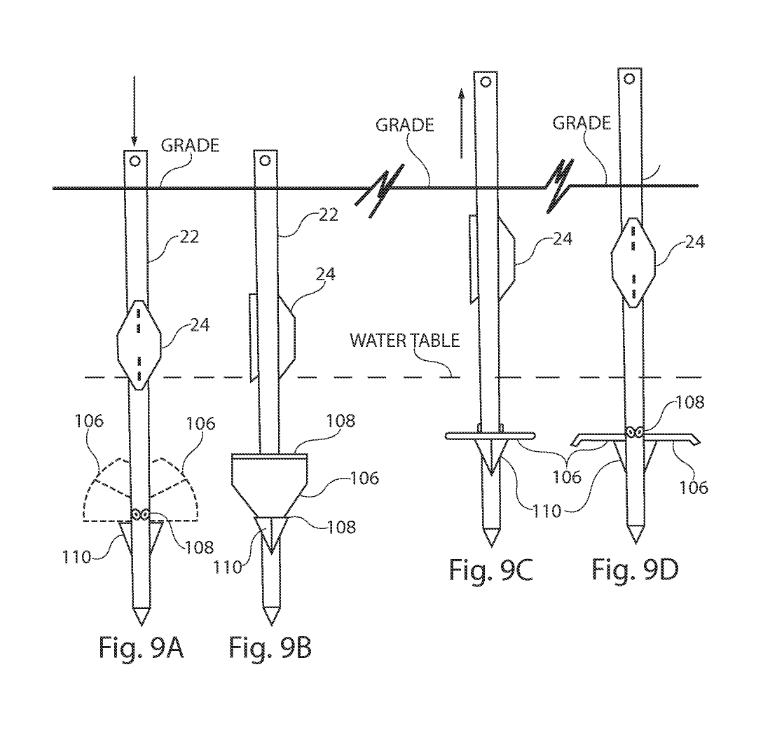

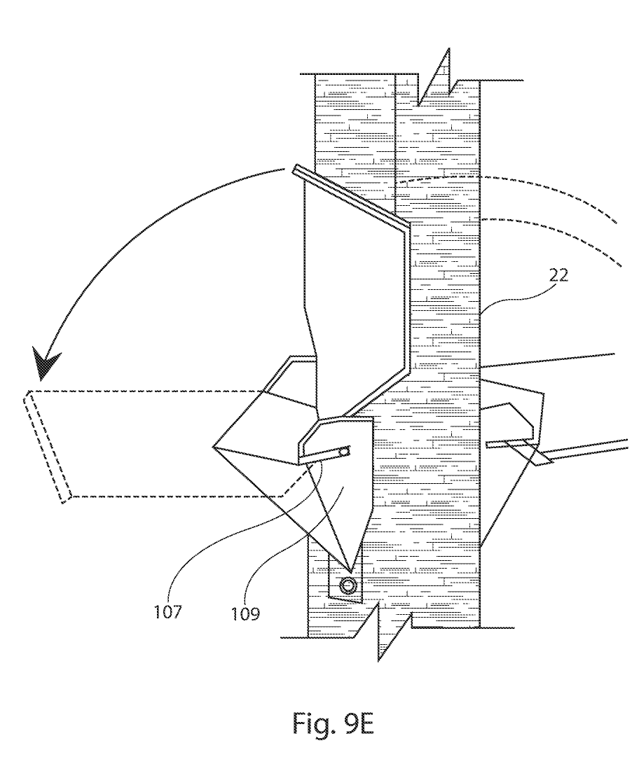

FIGS. 9A-9D are side elevational views and FIG. 9E an enlarged perspective view of yet other alternative embodiments of posts of the present disclosure.

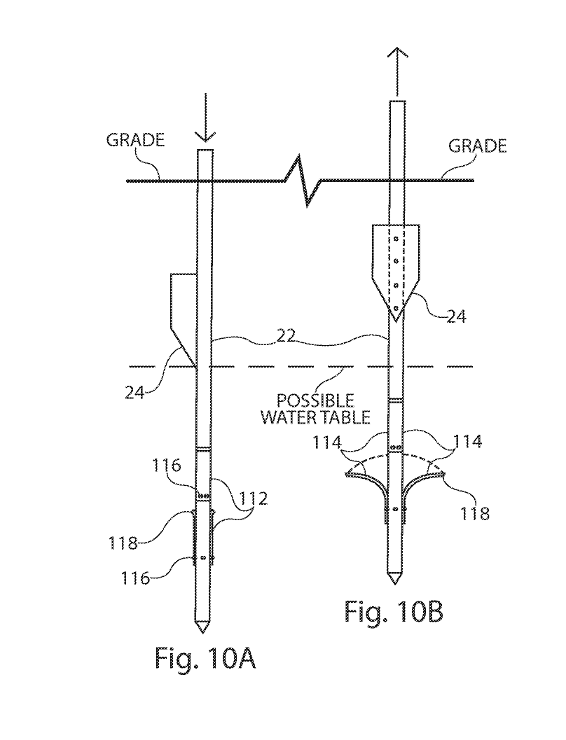

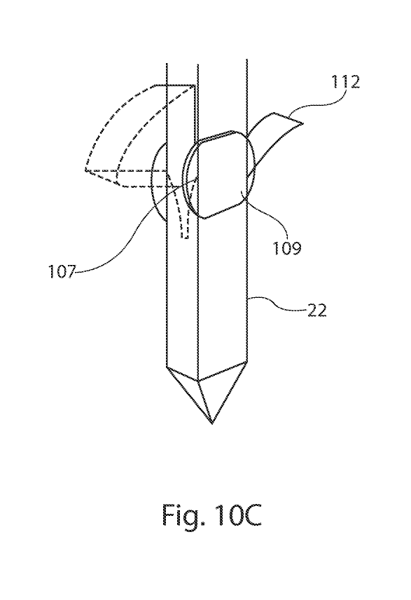

FIGS. 10A-10B are side elevational views and FIG. 10C a perspective view of still yet other alternative embodiments of posts of the present disclosure.

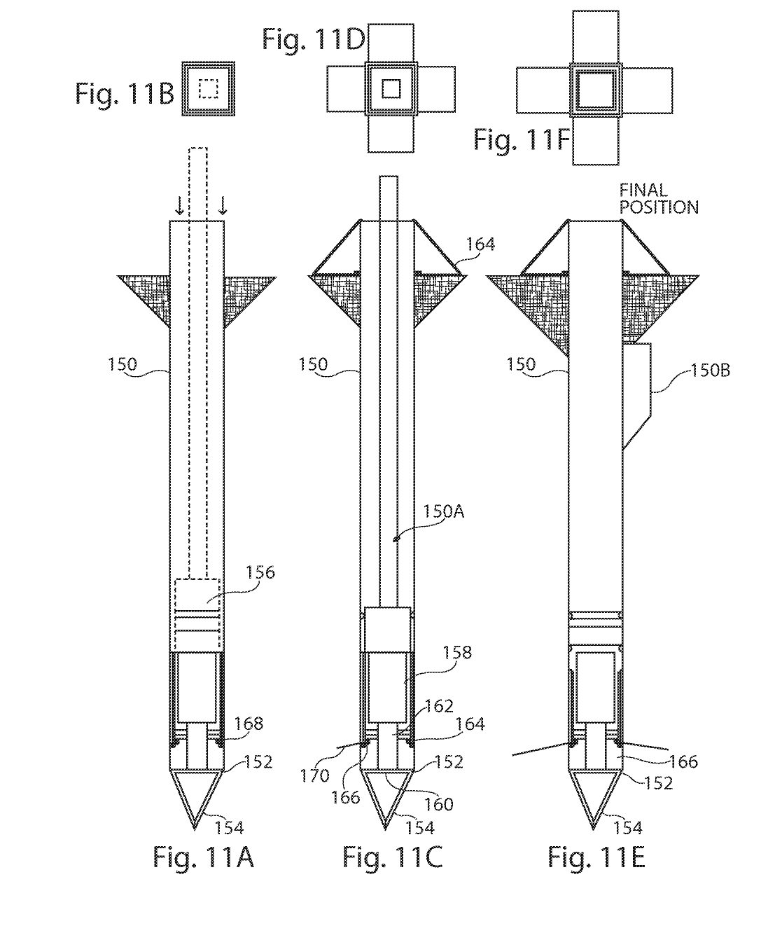

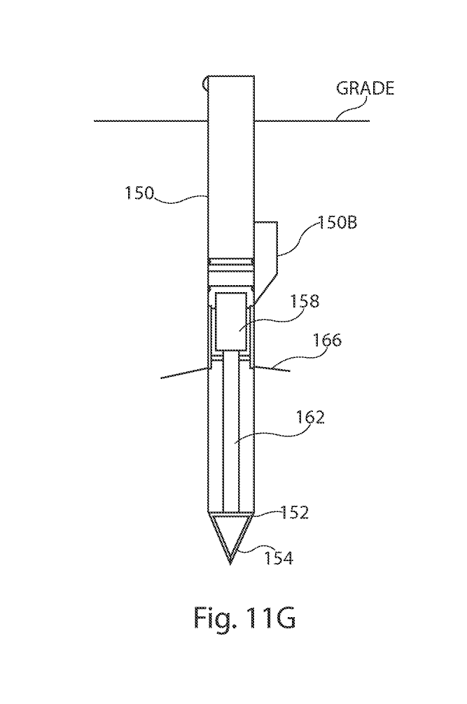

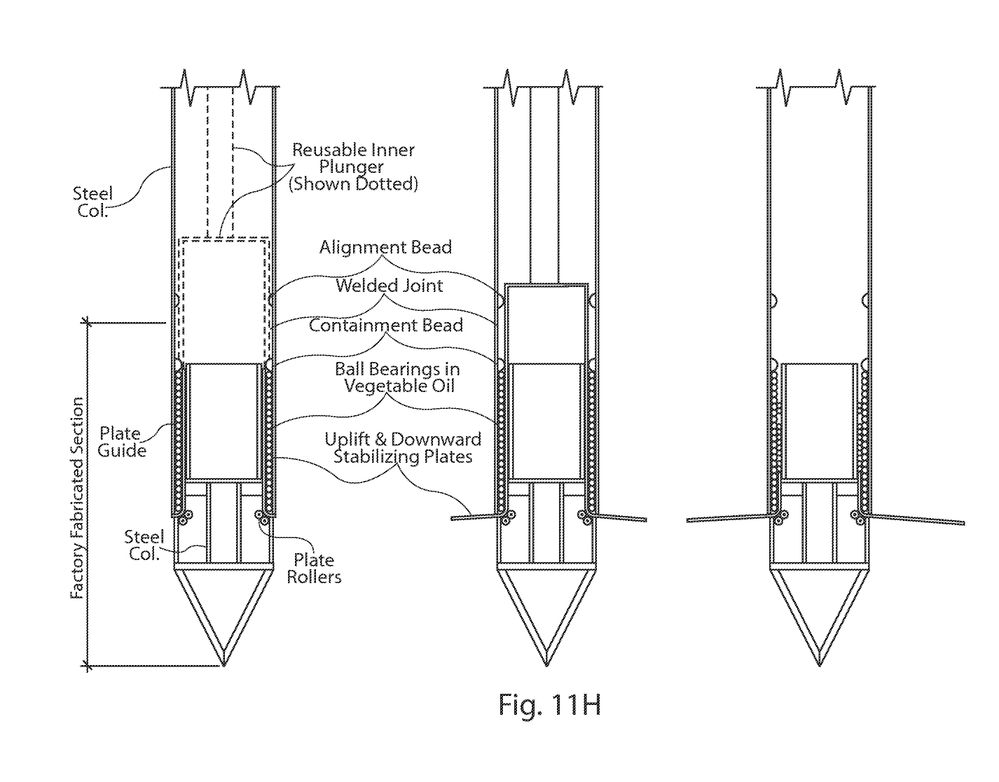

FIGS. 11A-11H are side elevational and top end views of yet another embodiment of post of the present invention.

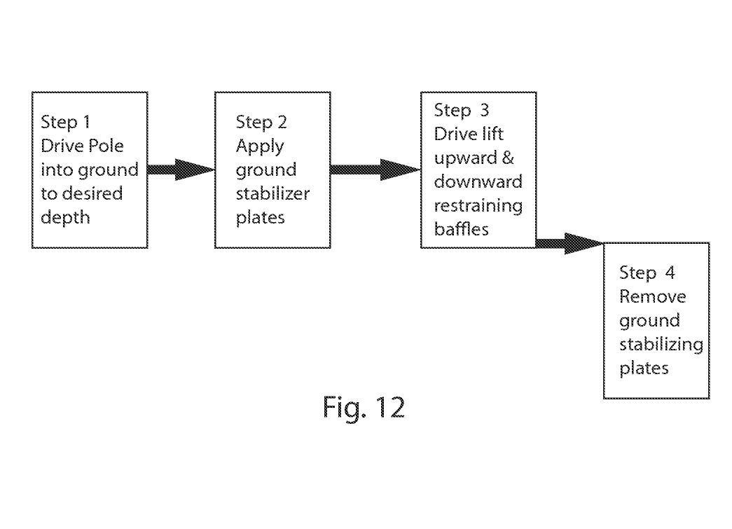

FIG. 12 is a flowchart illustrating a method of installing and stabilizing the post of FIGS. 11A-11H.

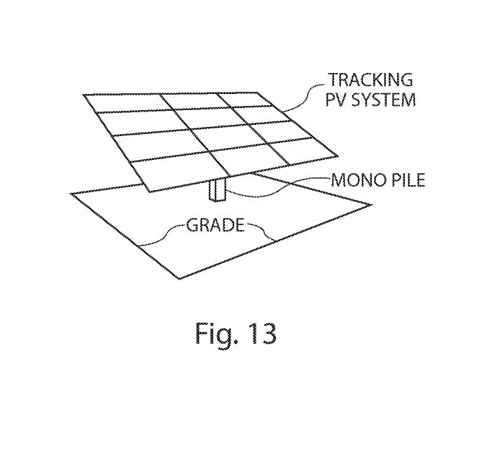

FIG. 13 is a perspective view of yet another embodiment of the present invention.

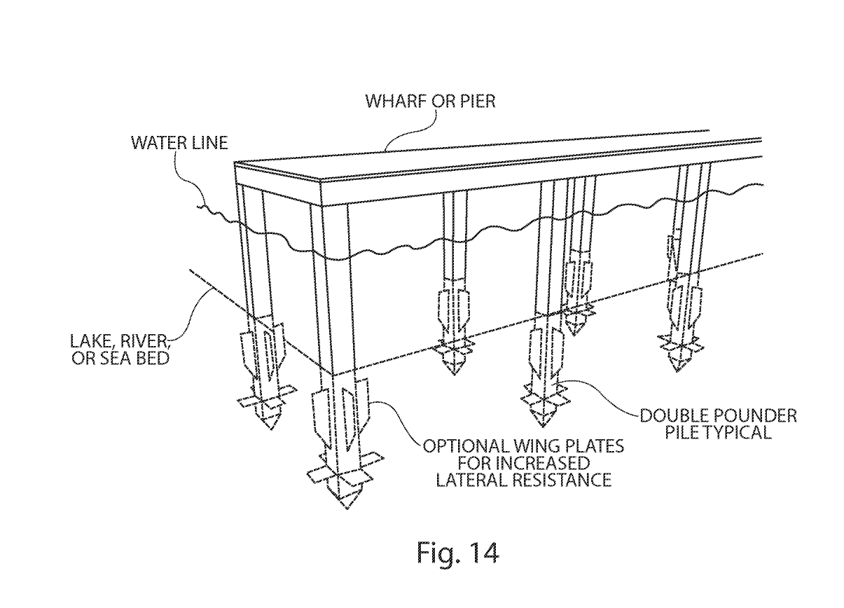

FIG. 14 is a perspective view of a wharf or pier in accordance with yet another embodiment of the present invention.

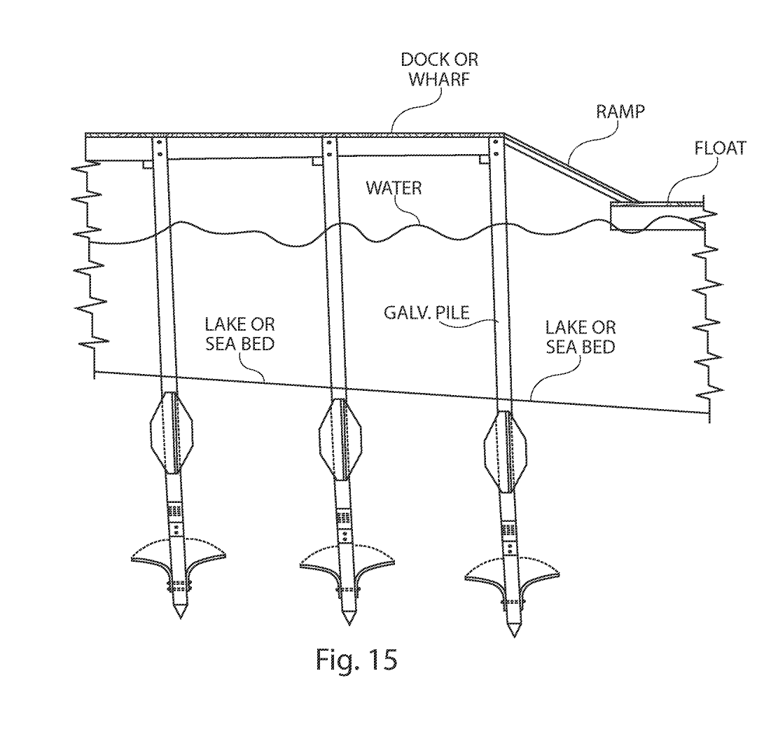

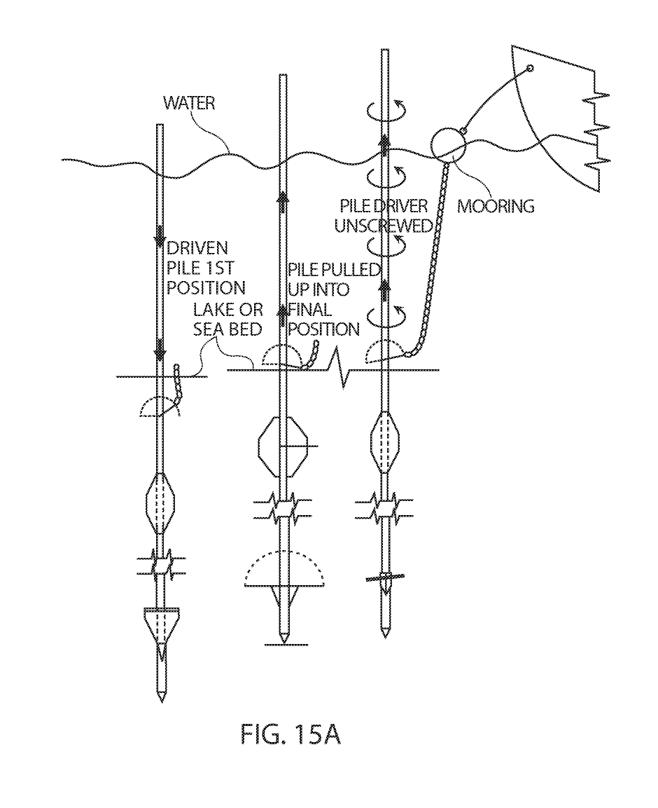

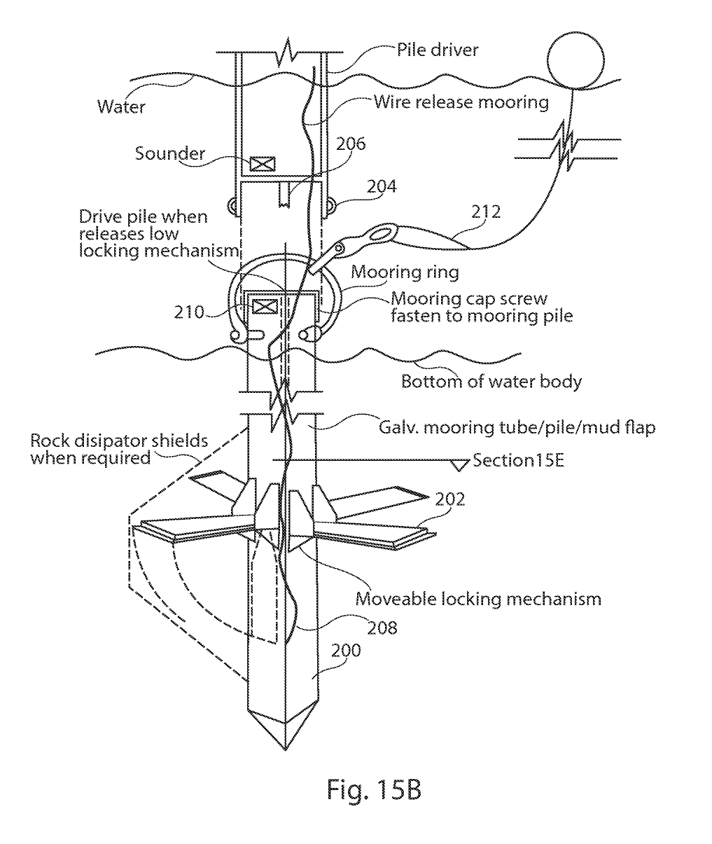

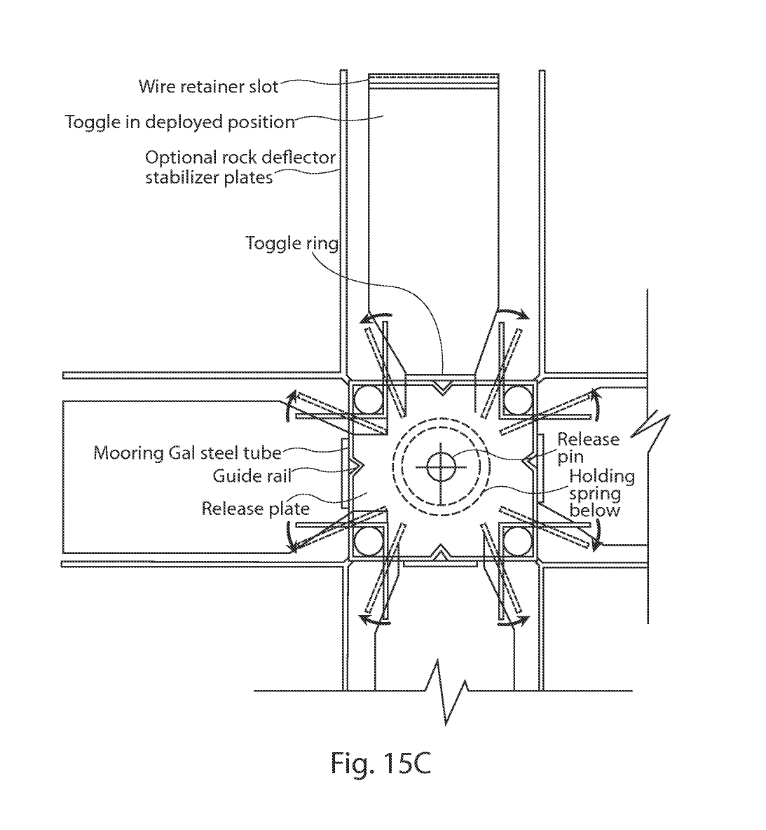

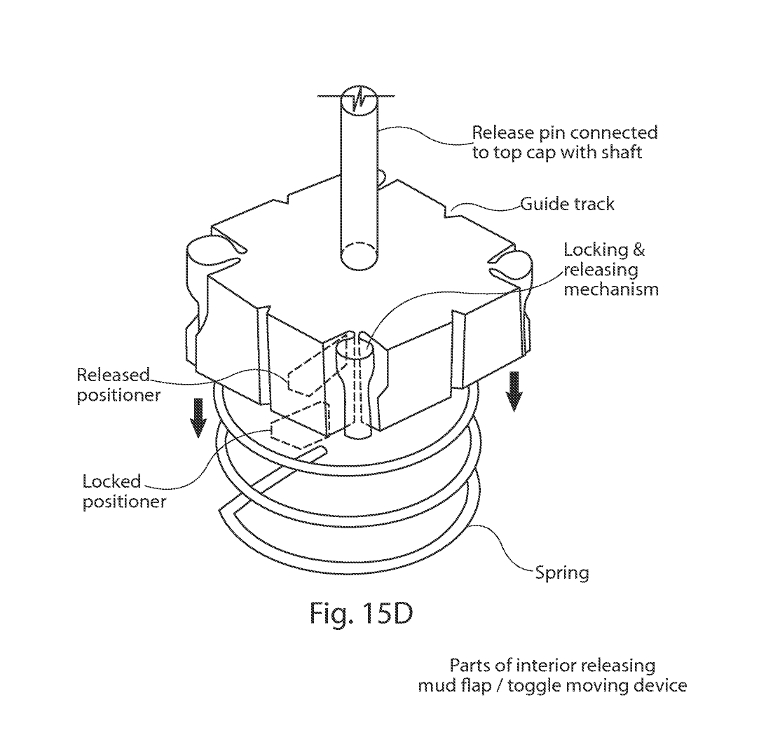

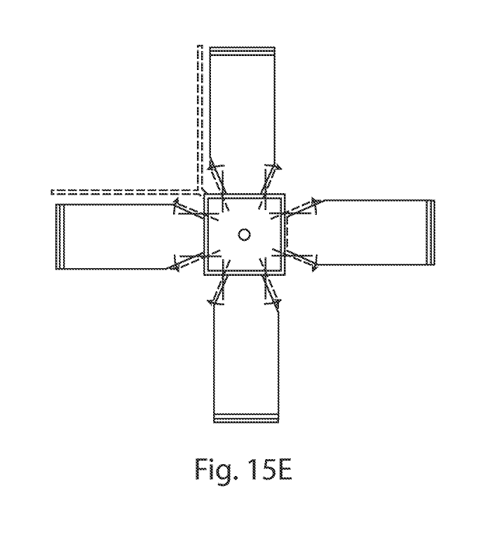

FIG. 15 is a view similar to FIG. 1 of a side elevation of a dock or wharf in accordance with another embodiment of the present invention. FIG. 15a is a view similar to FIG. 1 of a front elevational view of a mooring in accordance with yet another embodiment of the present invention and FIGS. 15b-15e illustrate alternative construction of mooring in accordance with the present invention.

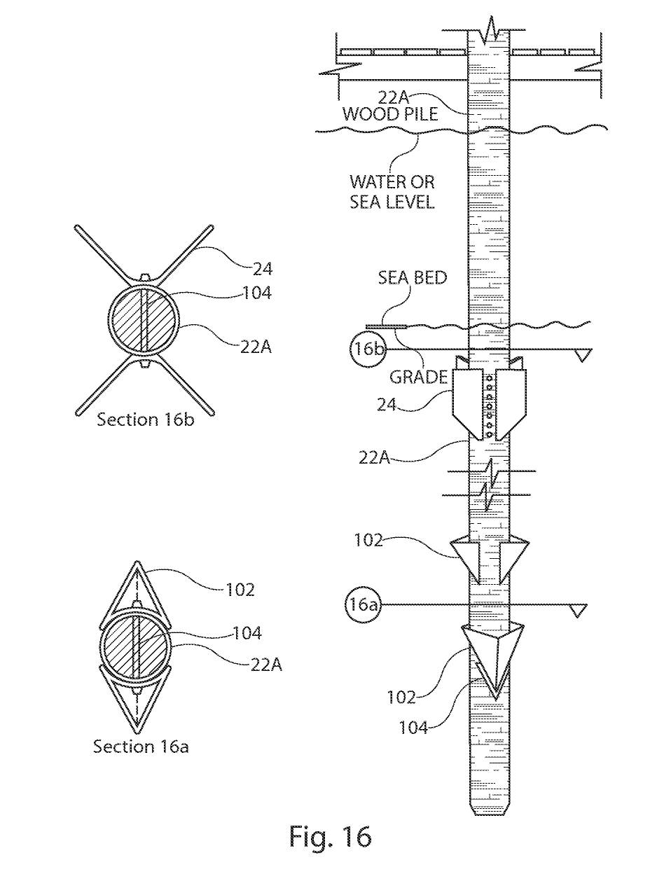

FIG. 16 is a prospective detail of a wood pile with wharf, pier, or building in accordance with another embodiment of the present invention.

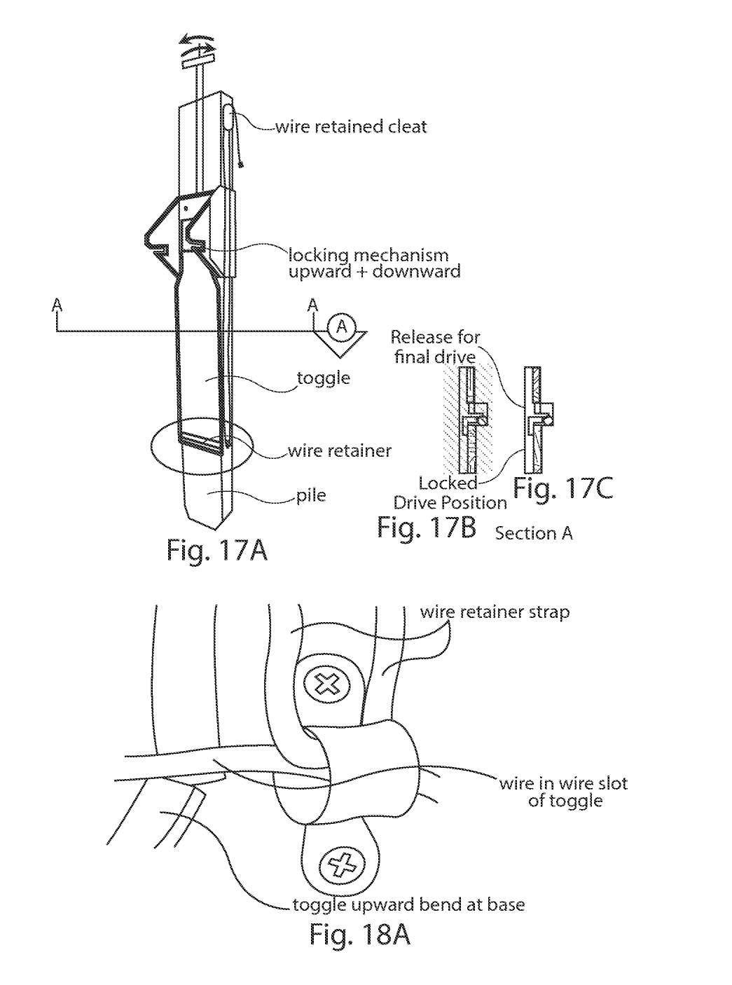

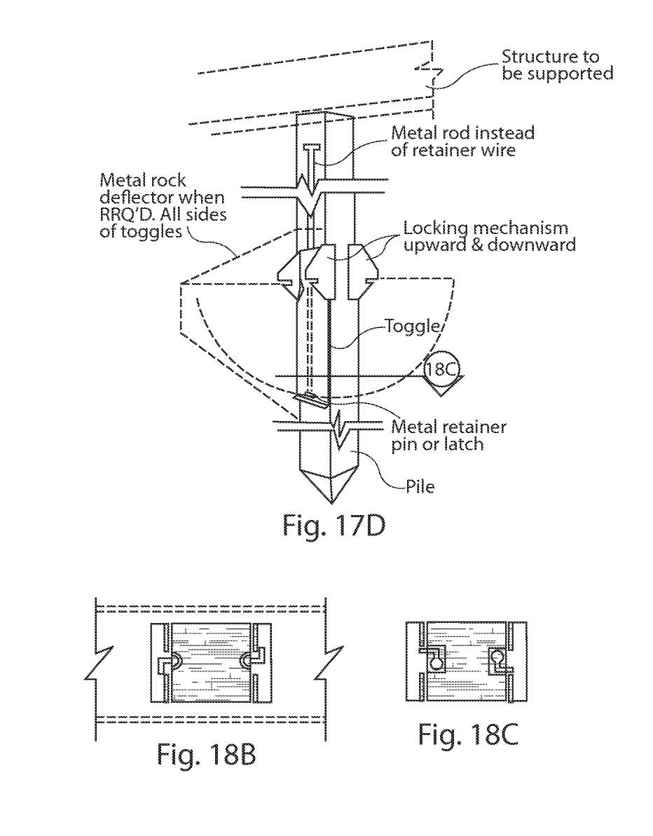

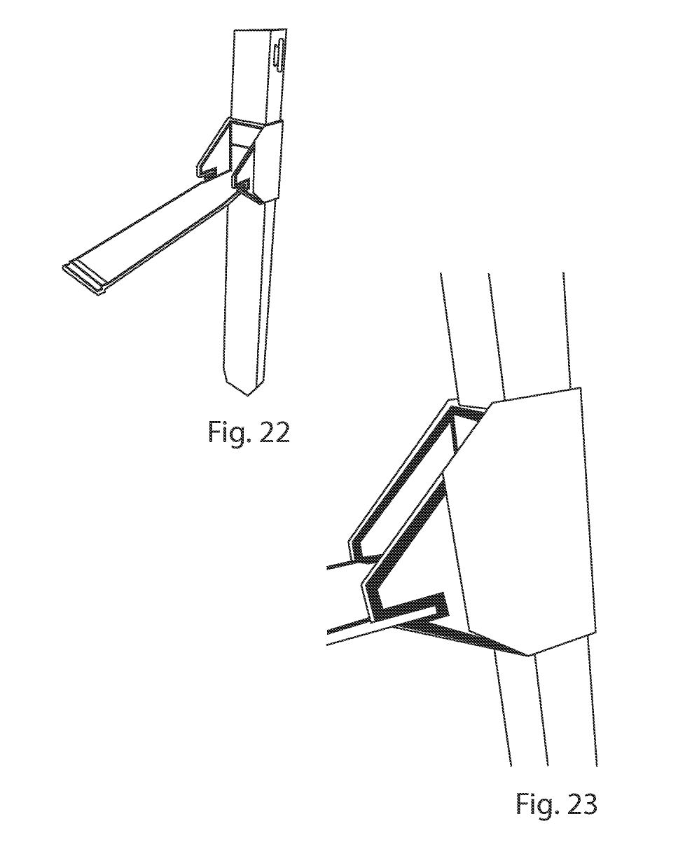

FIGS. 17-24 illustrate still yet other embodiments of the invention.

In the following description, reference is made to the accompanying drawings, which form a part hereof, and in which is shown, by way of illustration, various embodiments of the present disclosure. It is understood that other embodiments may be utilized and changes may be made without departing from the scope of the present disclosure.

FIG. 1 is an illustration of a front elevation view of a photovoltaic (PV) system 10, in accordance with a first exemplary embodiment of the disclosure. The system 10 includes a solar panel assembly 10 and a mounting assembly 20. The solar panel assembly 10 may include an array of solar panels 12, which may be physically joined to one another, as well as electrically connected.

The mounting assembly 20 includes a plurality of posts 22. In one embodiment posts 22 may be any pile, pole, stake, or any similar structure which may be positioned at least partially underground, and fixed firmly in an upright position. In one embodiment posts 22 may be sigma posts (as shown in the plan section of FIG. 2).

One or more stability elements 24 are attached to each post 22. The stability elements 24 may take the form of flat plates, and may be made, e.g. of galvanized steel. The elements or plates 24 may be of any dimensions, depending on the desired stability and/or the type of structure to be mounted onto the mounting assembly 20. As shown in FIG. 1, the plates 24 may be approximately 12″×24″× 3/16″. Preferably, the stability plates 24 include angled lower corners 25. The lower corners 25 may have an angle of about 45° to 75°, preferably about 60° from the horizontal plane, as shown in FIG. 1. The angled corners 25 allow the plates 24, for example when attached to posts 22, to be more readily driven into the ground. The plates 24 are attached to the posts 22 by any known attachment techniques, including welding, epoxies or other adhesives, rivets, screws, nuts and bolts or any other structural fastener, and the like. As shown in the plan section of FIG. 2, taken along line 14, the plates 24 may be attached to the post 22 with a bolt 26. Also, if desired, one or more half pyramid-shaped stabilizing elements or pyramid scoops 102, as shown in greater detail in FIGS. 8A-8C may be attached to the post 22.

Depending on the characteristics of the structure to be mounted, the position of attachment of the stability plates 24 and pyramid scoop 102 to the posts 22, as well as the underground depth of the plates 24, and pyramid scoop 102 may vary. As shown in FIG. 1, the structure to be mounted may be a solar panel assembly 10. For such a solar panel assembly 10, the stability plates 24 may preferably be attached to the posts 22 and buried to a depth of about 2′ from grade to the top of the plates 24, with the pyramid scoops 102 below stability plates 24 as shown in FIG. 1. For example, posts 22 may be about 10′ in height, with an embedment depth of about 8′4″ and an above-ground height of about 1′8″. The stability plates 24 may be positioned underground such that the flat surface of the plates 24 faces the same direction as the vertical component of the solar panels 12 of the assembly 10, as shown by the arrows in FIG. 4. That is, the buried flat surface of the plates 24 may face the same direction as the wind-bearing vertical component of the above-ground photovoltaic surface, thus providing underground resistance to prevent or minimize movement both horizontally and vertical uplift of the posts as the solar panels 12 are subjected to wind (see FIGS. 3 and 4).

As shown in the plan view of FIG. 3, the posts 22 of the mounting assembly 20 may be arranged in a rectangular fashion, with a first set of posts 22a defining a front of the assembly 20 and a second set of posts 22b defining a back of the assembly 20. A length (l) of the assembly 20 may be defined by the total distance between front posts 22a or back posts 22b, while the width (w) of the assembly 20 may be defined by the distance between adjacent front 22a and back 22b posts. Other geometric patterns may be produced from the positioning of the posts, depending on the shape and mounting positions of the structure to be mounted, as those having ordinary skill in the relevant field will readily understand.

The posts 22 may be attached to each other with cross members 28, thereby providing further structural strength and stability to the mounting assembly 20 and the system 10. Cross members 28 also can be attached side to side to provide additional stability (see FIG. 3). The cross members 28 may be any type of attachment member for providing stability and/or structural strength when attached between two or more posts 22. For example, the cross members 28 may be a rigid structure, such as a pole or angle. The cross members 28 may be 2″×2″× 3/16″ galvanized tube steel.

As shown in the side elevation view of FIG. 4, the cross members 28 may be attached to the posts 22 underground (e.g., at a position above, below or near the position of the plates 24) and/or above ground. The cross members 28 may be attached to the posts 22 before or after installing the posts 22 in the ground. For example, slots may be dug into the ground, into which the cross members 28 and posts 22 may be positioned, and then backfilled. The cross members 28 may be attached to the post 22 by any known attachment techniques, including welding, rivets, epoxies or other adhesives, screws, nuts and bolts or any other structural fastener, and the like. As shown in FIG. 2, the cross members 28 may be attached to the post 22 with two self-drilling truss-head screws 29.

The cross members 28 may attach posts 22 in pairs, as shown in FIG. 3. The cross members 28 may attach posts 22 along an axis orthogonal to the flat surface of the plates 24 (e.g., as shown in FIG. 3, the cross members 28 attach front posts 22a to back posts 22b along an axis orthogonal to the surface of the plates 24). By attaching cross members 28 to posts 22 orthogonal to the plane of the surface of the plates 24, stability to the mounting assembly 20 is provided to the system 100 to counter wind against the face of the solar panel assembly 10. A structure to be mounted, such as the solar panel assembly 10, may be of a size such that it may be desirable to form the mounting assembly 20 of two or more pairs of posts 22 (e.g., four pairs of posts 22, as shown in FIG. 3). However, the mounting assembly 20 may include any number of posts 22, and may include cross members 28 which may attach posts 22 in any direction, for example, front posts 22a to adjacent back posts 22b, front 22a to front 22a, back 22b to back 22b, as well as front posts 22a to non-adjacent back posts 22b.

The solar panel assembly 10 may be mounted to the mounting assembly 20, for example, by attaching mounting posts 16 of the solar panel assembly 10 to above-ground portions of the posts 22 of the mounting assembly 20. While the mounting assembly 20 has been described primarily with respect to mounting a solar panel assembly 10, any other assembly may be mounted to the mounting assembly 20 of the present disclosure. For example, the mounting assembly 20 may be used for mounting other types of photovoltaic systems, including PV concentrators and mirror assemblies, as well as billboards, signs, buildings, or any other structure which may be subjected to winds.

Existing mounting structures may be retrofitted for stability utilizing principles provided by the present disclosure. For example, an existing mounting structure for a photovoltaic system may include posts 22 which have previously been driven into the ground, and to which a solar panel assembly 10 has been attached. To provide increased stability, particularly in loose or sandy soil, plates 24 may be attached to the posts 22. In order to attach the plates 24, an area of ground surrounding the posts 22 may be dug out, for example to a depth of about 3 feet. Plates 24 may then be attached to the posts, for example with bolts 26. For further stability, cross members 28 may be attached between adjacent front 22a and back 22b posts, for example, by digging a trench between posts 22, attaching cross members 28, and backfilling the trenches.

FIG. 5 is a flowchart 500 illustrating a method of stabilizing a preinstalled ground mounting assembly having a plurality of posts 22 buried at least partially in the ground, in accordance with an embodiment of the disclosure. As shown by block 502, an area of ground surrounding each of the posts 22 is excavated. At block 504, a H stabilizing plate 24 is attached to each of the posts 22, in an area exposed by the excavation. At block 506, the excavated area is backfilled. The stabilizing plates 24 may be attached to the posts 22 at a position such that the top edge of the stabilizing plates 24 is buried to a depth of about 1 foot underground.

The method may further include excavating a portion of ground between posts 22a defining a front of said mounting assembly and posts 22b defining a back of the mounting assembly 20, and attaching a cross member 28 between each of front posts 22a and an adjacent one of the back posts 22b.

FIG. 6 is a flowchart 600 illustrating a method of ground mounting a structure. As shown by block 602, a mounting assembly 20 is formed by driving a plurality of posts 22 into the ground, each of the posts 22 being connected to a stabilizing plate 24 and optionally a scoop pyramid—102. At block 604, the structure is attached to an above-ground portion of the mounting assembly 20. The posts 22 may be driven into the ground to a position such that the stabilizing plates 24 are buried to a depth of about 2 feet underground. The structure may be a solar panel array 10.

The method may further include excavating an area of ground between posts 22a defining a front of the mounting assembly 20 and posts 22h defining a back of the mounting assembly 20, and attaching a cross member 28 between each of the front posts 22a and an adjacent one of the back posts 22b, and backfilling the excavated area.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. For example, as illustrated in FIGS. 7A-7C, the piles or posts 100A, 100B, 100C may have different cross-sections, and may have multiple plates 102 mounted thereon. Alternatively, as shown in FIGS. 8A-8C, one or more additional stabilizing elements in the form of a half pyramid-shaped structure 102 may be fixedly mounted, using, for example, mounting plates 104, to posts 22 for stabilizing the structure against uplift. In such embodiment, the half pyramid-shaped stabilizing elements or pyramid scoops preferably are fixed to the lower half of posts 22, but can be placed anywhere along the post to maximize its uplift resistant strength. In still yet another embodiment, shown in FIGS. 9A-9D, the stabilizing elements may take the form of togel mounted anchor plates 106 which are pivotably mounted to posts 22 around a pivot 108. In the case of pivotably mounted stabilizing elements or plates 106, the post typically will be driven in the ground below a target position, e.g. as shown in FIGS. 9A and 9B. The posts would then be pulled vertically into a final position causing the togel mounted plates 106 to fan out against a stop plate 110 which, in a preferred embodiment, comprises a half pyramid-shaped element. Alternatively, as shown in FIG. 9E, togel mounted plates 106 may be locked in place by sliding into slots 107 in brackets 109. Once locked in place, plates 106 have the capacity to resist both upward and downward motion on the pile.

In yet another alternative, as shown in FIGS. 10A and 10B, the stabilizing elements may take the form of bendable plates 112 having reduced resistance bending points 114, fixed to post 22 adjacent their lower ends by fasteners 116. The upper, free ends 118 of plates 112 preferably are curved outwardly. Alternatively, as shown in FIG. 10C, the plates 112 may be pivoted and locked in position in slotted brackets 109 plates with slot noted as 107 similar to those shown in FIG. 9E. The disclosure also advantageously may be used with solar thermal energy systems, docks, wharfs, buildings, and moorings.

Referring now to FIGS. 11A-11H, and FIG. 12, in yet another embodiment of the invention, the pole comprises a double pounder pile driven mono pole comprising an elongate hollow pole 150, preferably having a square cross section, capped at its distal end 152 by a pyramid-shaped point 154. The double pounder pile driven mono pole 150 includes a follower guide 158 that is mounted to the top plate 160 forming the pyramid point 154 via steel tube spacer 162 which may vary in length (see FIG. 11G). In use, the double pounder pile driven mono pole is first driven into the ground to a desired depth, using a conventional pole or pile driver, in step 1. The pile is then stabilized with ground stabilizer plates 164 step 2. Then, a plunger 150 A or ram is driven down the inside of pole 150, in a step 3, to drive steel plates 170 substantially horizontally outward, over plate rollers 166, which may be lubricated, if desired, with an environmentally safe lubricant such as vegetable oil or the like, through slots 168 formed adjacent the distal end of pole 150 to provide for uplift and downward restraining baffles or wings the double pounder may be equipped with plates 150 B to resist lateral load. Also, as shown in FIG. 11G, the double pounder can be positioned at any place along the pile. Soils are stratified. Thus, it is desirable to have the plates come out where they could to do the most good. The double pounder design allows this to happen. It can be placed anywhere along the pile. Also, the stabilizing plates are needed during the double pounding of the pile for its initial installation, however they do not need to stay in the final position, and they can be removed. They are only there so that the pile doesn't get driven down deeper than what the desired engineering requirements are. Also, it should be noted that plates 150B may be placed anywhere along the double pounder for a maximum stability. Also, as shown in FIG. 11g, the grade stabilizer plates may be omitted (see FIG. 12). The double pounder pile driven mono pole may then be used in combination with other like or different poles such as previously described, or may be used alone for mounting PV systems such as shown in FIG. 13. The resulting mono pole with a solar panel array attached to it, is capable of counteracting significant loads, and offers significant advantages over conventional concrete spread footing which require steel reinforced concrete and anchor bolts especially in remote locations such as deserts or along power line easements (See FIG. 13). etc.

Referring now to FIG. 14, in yet another embodiment of the invention, a dock or wharf may be mounted to a plurality of ground mounting poles as above described, in which the distal ends of the poles are driven into the lake, river or sea bed, while the proximal ends extend above the water, and a dock or wharf is mounted thereon. FIG. 15 shows another embodiment of the invention for docks and wharfs. Alternatively, as shown in FIG. 15A, the ground mounting poles as previously described may be driven into a lake, river or sea bed, the pile pulled up into a final position, and the pile driver uncoupled, e.g. by unscrewing, and a mooring attached to the proximal end of the pole. However, the mooring shown in FIG. 15A in practice would require periodic inspection of the mooring and chain, which in some waters is generally every one to three years. Once the toggles were deployed getting the device out of the bottom of the harbor would do circumferential damage to the bottom, and therefore the eco-system around the pile. FIGS. 15B-15F, illustrate an alternative mooring in which we first pound the mooring pile 200 into the bottom of the harbor, but then using a releasing mechanism that lets the toggles 202 float back down the side of the pile and be retrieved in a more environmentally friendly manner. The pile mooring is installed with a pile drive mechanism with a spring 204 that latches on to the cap of the mooring. The release drive pin 206 is removable in this pile system while driving it would be removed, and during removal the drive pin push would be installed and push the release plate downward and release the movable locking mechanism removed in retrieval. The pile uses a retaining wire 208 to hold the toggle flat against the pile mooring during initial driving. Once the pile was driven to the bottom to approximately 2′ from where the pile would be situated, the wire would be released, and then the pile driver would continue to drive the mooring the additional 2′ to release the flaps which would lock into position. Upon needing inspection the same pile driving service that as used would have a pin in the middle of the pile for the release of the toggle locking mechanism, and there would be a sender and a sounder 210 inside of the pile cap itself and the pile driver. This will allow the barge operator or boat operator to determine the location of the mooring in the murky water. This is especially important in waters with muddy conditions at the bottom to latch onto the pile mooring. The pin release drive would then drive the central pin and plate down into the mooring and release the lower retainers to an outward position, thereby permitting one to lift the mooring out without any major destruction to the bottom of the seabed. The mooring chains 212 could be checked, the cap pile mooring would be taken off, all mechanisms checked, e.g. at required time intervals determined by the Harbor Master or Government Body, for standard maintenance, and lubricated and repairs needed to worn parts and would be reinstalled inside or outside the pile mooring, and the mooring would be reinstalled in approximately the same location as it had been taken up.

See also FIG. 16, which illustrates another embodiment of the disclosure in the form of a wharf, pier, or building. As illustrated in FIG. 16, which illustrates how the scoop or solid pyramids would be attached and work on a standard wood pile in possible length of 20′ to 60′ long. In FIG. 16A a galvanized steel or stainless steel scoop or solid pyramid is thru bolted to the wood pile to provide upward resistance to the pile from tidal, wave, or ice conditions. FIG. 16 B shows the lateral plates 24 being thru bolted through the wooden pile number 22A to resist lateral load to the structure above.

Referring to FIGS. 17-24, there is illustrated yet another embodiment of the invention in which the toggle plates may be locked in place with a locking mechanism so that the tile or posts would resist not only vertical uplift, but also downward pressure as well. The locking toggle plates as will be described in more detail below may be used alone, or in combination with the double pounder retractable plates discussed previously. In such embodiment, the double pounder retractable plates should be placed near the bottom or distal end of the piles or posts, while the locking toggle plates located intermediate the distal end of the piles or poles and the proximal ends or top ends of the piles or posts.

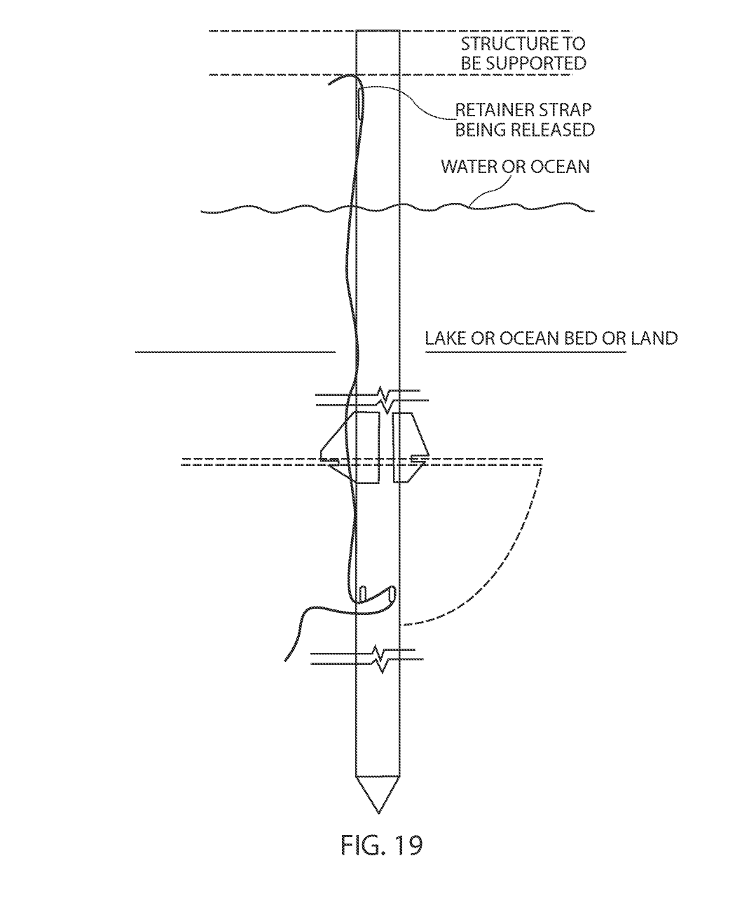

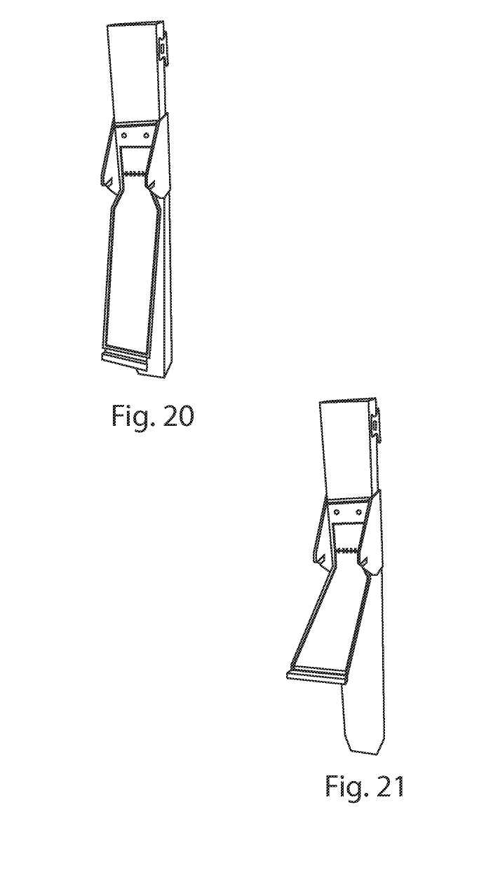

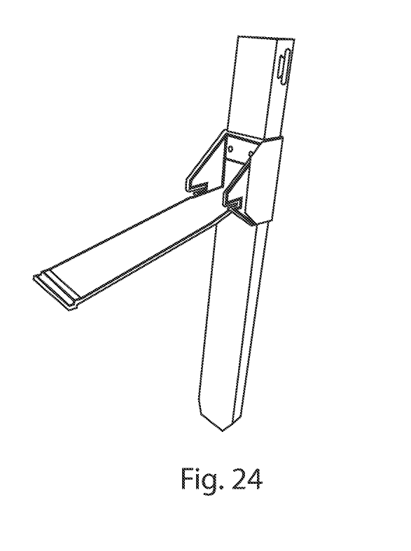

Referring to FIGS. 17-24, the toggle locking mechanism tied to the post by stainless steel wire (FIGS. 17A and 18B) show the toggle in the driving position and there would be either 2 or 4 toggles (or more) on each pile. The pile would be driven to a recommended depth about a foot or two less than the final finished depth. The retainer wire would be removed (as seen in FIG. 19). The pile would then be driven into the locking mechanism by driving the pile downward (FIGS. 20 and 21) instead of lifting to set the toggle as discussed previously. Alternatively, as shown in FIGS. 17B-17D and 18B-18C, the wire holding system which is a wire viable solution for small piles and for small moorings; however it generally will not work with larger piles such as 12′×12′ wooden piles, or 18″ round 24″ tubes piles. There may be 40′ long or even larger piles which may be 20 or 24″ square, and 80′ long. This will require a different mechanism. Instead of the wire that is shown in FIGS. 17A and 18A. FIGS. 17B-17D and 18B-18C shows a rod latching releasing mechanism that would be inside the metal pile or routed into a wooden pile. The mechanism locking metal so that the metal retaining pin or latch at the bottom would be connected to a continuous rod to above grade, and can simply be twisted in an open position and the pile driven no that the flaps will be released into the toggle locking mechanism. This will provide both downward and upward strength of the pile. Also noted on FIG. 17D are rock deflectors where required depending on soil conditions. FIGS. 21-24 show how the toggle may be locked in the toggle locking mechanism to take both upward and downward loads. This occurs when the angle shaped toggle pushes out the lower lesser steel locking mechanism and forces the toggle into the slot and against the it larger upper locking mechanism strut, click and lock. This upper larger beefier structure is such to resist breakage from the pile driving hammer. This latter feature is preferable in that it would be driven and locked in both directions vertically and downward and truly make the pile a much stronger structural element. Also, the toggles or flaps preferably should be nearer the top, like the double pounder in FIG. 11G. FIG. 24 shows the toggle just before it engages the slot at this point the toggle is bending the steel lower locking mechanism just before it snaps into the locking slot.

In yet another embodiment, not shown, ground mounting poles as previously described may be driven into the ground adjacent a building or other structure and used to reinforce or stabilize the building or other structure. The ground mounting poles also may be used simply for mounting antennas, flagpoles, light poles, signs, etc.

All such modifications and variations are intended to be included herein within the scope of the present disclosure and protected by the following claims.

1. A ground mounted structure, comprising:
a ground mounting pole having a proximal end extending from the ground, and a distal end driven into the ground, wherein the ground mounted structure comprises a double pounder pile driven mono pole comprising an elongate hollow pole, said elongate hollow pole being open at its proximal end to accommodate a plunger, and capped at its distal end, and having a follower mounted to the cap within the hollow, said mono pole further having at least one stabilizing element extendable from the pole and locked in place.

2. The ground mounted structure of claim 1, characterized by one or more of the following features:
(a) further including one or more ground stabilizing elements affixed to the mono pole above ground for resistance to the plunger strikes;
(b) wherein the cap is shaped as a pyramid;
(c) wherein said pole is square in cross-section.
(d) wherein said at least one stabilizing element adjacent the pole distal end comprises a flat plate shaped structure extending through a slot in a wall of the mono pole, and
(e) wherein said at least one stabilizing element adjacent the pole distal end comprises a flat plate shaped structure extending through a slot in a wall of the mono pole, adjacent the distal end thereof.

3. The ground mounted structure of claim 2, characterized by one or both of the following features:
(a) wherein said mono pole includes plate rollers adjacent the slots for shaping and directing the at least one flat plate sideways from the mono pole, and
(b) wherein the slot is adjacent a distal end of the pole.

4. The ground mounted structure of claim 1, wherein the structure is selected from the group consisting of a solar panel solar panel array, a pier, a wharf, a mooring, an antenna and a building structure.

5. The ground mounted structure of claim 4, wherein the solar panel is selected from the group consisting of a solar thermal collector panel, a photovoltaic collector panel a stationary solar panel, and a tracking solar panel.

6. A method for mounting a structure to the ground comprising providing a double pounder pile driven mono pole as claimed in claim 1;
driving a distal end of the mono pole into the ground to a desired depth;
extending the stabilizing elements from the mono pole, and locking the stabilizing elements in place.

7. The method of claim 6, characterized by one or more of the following features:
(a) wherein the mono pole is set to a desired depth by a pile driver,
(b) wherein the stabilizing elements are driven from the mono pole by a pile driver,
(c) wherein the stabilizing elements are driven from the inside of the mono pole to a desired position, and
(d) including the step of fixing ground stabilizer plates to the mono pole.

8. A pier, wharf, mooring, building or antenna structure mounted to a ground mounting pole having a proximal end extending from the ground, and a distal end driven into the ground, wherein the ground mounting assembly comprises a double pounder pile driven mono pole or multiple mono poles having at least one stabilizing element adjacent the pole distal end, wherein the mono pole or multiple mono poles each comprising an elongate hollow pole, said elongate hollow pole being open at its proximal end to accommodate a plunger, and capped at its distal end, and having a follower mounted to the cap within the hollow, such mono pole further having at least one stabilizing element extendable from the pole and locked in place.

9. The structure of claim 8, characterized by one or more of the following features:
(a) wherein the at least one stabilizing element is extendable from adjacent the distal end of the pole,
(b) further including one or more ground stabilizing elements affixed to the mono pole above ground or for mooring just above a sea, a lake, or a riverbed level,
(c) wherein the distal end of the mono pole is shaped as a pyramid,
(d) wherein said pole is square in cross-section, and
(e) wherein said at least one stabilizing element comprises a flat plate shaped structure extending through a slot in a wall of the mono pole, wherein said mono pole preferably includes plate rollers for shaping and directing the at least one flat plate sideways from the mono pole, and wherein the plate rollers preferably are adjacent the distal end of the pole.

10. A method for ground mounting a solar energy array, pier, wharf, mooring or building structure comprising providing a double pounder pile driven mono pole as claimed in claim 1, driving the distal end of the mono pole into the ground to a desire depth; fixing ground stabilizing plates to the proximal end of the mono pole; and
driving the stabilizing elements from the inside of the mono pole.

11. The method of claim 10, characterized by one or more of the following features:
(a) wherein the mono pole is set to a desired depth by a pile driver,
(b) wherein the stabilizing elements are driven from the mono pole by a pile driver, and
(c) wherein the stabilizing elements are adjacent the distal end of the mono pole.

12. A ground mounted structure comprising a ground mounting pole having a proximal end extending from the ground and a distal end extending into the ground, said pole having at least one pivotally mounted plate attached thereto and locked in place to resist uplift and/or downward thrust.

13. The ground mounted structure of claim 12, characterized by one or both of the following features:
(a) wherein the locking mechanism is accessible from above ground, wherein the locking mechanism preferably is acctuatable through a wire, rod or chain, and
(b) further comprising a lock deflector shielding the pivotable stabilizing elements, at least in part.

14. A ground mounting assembly for mounting a structure, comprising a ground mounting pole having a proximal end extending from the ground, and a distal end extending into the ground, said pole having at least one pyramid-shaped stabilizing element buried in the ground.

15. The ground mounted structure according to claim 14, wherein the pyramid-shaped stabilizing element is open upwards towards the surface of the ground.

16. A ground mounted structure, comprising:
a structure mounted to a ground mounting pole having a proximal end extending from the ground, and a distal end driven into the ground, wherein the ground mounted structure comprises a double pounder pile driven mono pole comprising an elongate hollow pole, said elongate hollow pole being open at its proximal end to accommodate a plunger, and capped at its distal end, and having a follower mounted within the hollow, such mono pole further having at least one stabilizing element adjacent the pole distal end.

17. The ground mounted structure of claim 16, characterized by one or more of the following features:
(a) further including one or more ground stabilizing elements affixed to the mono pole above ground,
(b) wherein the cap is shaped as a pyramid,
(c) wherein said pole is square in cross-section,
(d) wherein said at least one stabilizing element adjacent the pole distal end comprises a flat plate shaped structure extending through a slot in a wall of the mono pole, adjacent the distal end thereof wherein said mono pole preferably includes plate rollers adjacent the distal end thereof for shaping and directing the at least one flat plate sideways from the mono pole, and/or wherein said mono pole includes plate rollers adjacent the distal end thereof for shaping and directing the at least one flat plate sideways from the mono pole,
(e) wherein the structure is selected from the group consisting of a solar panel, solar panel preferably array, a pier, a wharf, a mooring, an antenna, and a building structure, wherein the solar panel is selected from the group consisting of a solar thermal collector panel, a photovoltaic collector panel, a stationary solar panel, and a tracking solar panel,
(f) wherein the follower is spring mounted within the hollow,
(g) further including one or more ground stabilizing elements affixed to the mono pole above ground or for mooring just above sea, lake, or riverbed level,
(h) wherein the distal end of the mono pole is shape as a pyramid, and
(i) wherein said mono pole is square in cross-section.

18. A method for mounting a structure to the ground comprising providing a double pounder pile driven mono pole as claimed in claim 17,
driving the distal end of the mono pole into the ground to a desired depth;
fixing ground stabilizing plates to the proximal end of the mono pole; and
driving the stabilizing elements from the inside of the mono pole in position adjacent the distal end of the mono pole.

19. The method of claim 18, characterized by one or more of the following features:
(a) wherein the mono pole is set to a desired depth by a pile driver,
(b) wherein the stabilizing elements are driven from the mono pole by a pile driver,
(c) wherein the mono pole is set to a desired depth by a pile driver; and
(d) wherein the stabilizing elements are driven from the mono pole by a pile driver.

20. A pier, wharf, mooring, building or antenna mounted to a ground mounting pole having a proximal end extending from the ground, and a distal end driven into the ground, wherein the ground mounting assembly comprises a double pounder pile driven mono pole or multiple mono poles having at least one stabilizing element adjacent the pole distal end, wherein the mono pole or multiple mono poles each comprising an elongate hollow pole, said elongate hollow pole being open at its proximal end to accommodate a plunger, and capped at its distal end, and having a follower mounted within the hollow, such mono pole further having at least one stabilizing element adjacent the pole distal end.

21. A method for ground mounting a solar energy array, pier, wharf, mooring or building structure comprising providing a double pounder pile driven mono pole as claimed in claim 16, driving the distal end of the mono pole into the ground to a desire depth; fixing ground stabilizing plates to the proximal end of the mono pole; and driving the stabilizing elements from the inside of the mono pole in position adjacent the distal end of the mono pole.

22. The pier, wharf, mooring, building or antenna of claim 21, wherein the follower is spring mounted within the hollow.
